(19) United States
(12) Patent Application Publication
(10) Pub. No.: US 2026/0161041 A1
(43) Pub. Date: Jun. 11, 2026

(54) OPTICAL MODULATOR, LIGHT SOURCE MODULE, AND OPTICAL MODULATION METHOD

(71) Applicant: TDK Corporation, Tokyo (JP)

(72) Inventors: Kazuki NAKADA, Tokyo (JP); Shigeru Mieda, Tokyo (JP)

(73) Assignee: TDK Corporation, Tokyo (JP)

(21) Appl. No.: 19/405,532

(22) Filed: Dec. 2, 2025

(30) Foreign Application Priority Data
Dec. 5, 2024 (JP) 2024-212434

(51) Int. Cl. G02F 1/225; G02F 1/21

(52) U.S. Cl. CPC G02F 1/2255; G02F 1/212

(57) ABSTRACT

Provided is an optical modulator with excellent responsiveness and stability capable of controlling the output light of the optical modulator at high speed and in a stable manner. An optical modulator 101 of one aspect includes an optical modulation element 11 in which multiple optical waveguides are formed on a thin film made of a material having an electro-optic effect, an electrode arranged on the thin film and applying an electric field to the multiple optical waveguides, drive circuitry 120 configured to apply a modulation voltage to the electrode, bias application circuitry 130 configured to apply a bias voltage to the electrodes, and feedforward control circuitry 150 configured to compensate for DC drift occurring in the multiple optical waveguides. The feedforward control circuitry changes the bias voltage output by the bias application circuitry over time based on a transfer function previously set according to the characteristics of the DC drift.

### CROSS-REFERENCE TO RELATED APPLICATION

This application claims a priority, under the Paris Convention, to Japanese Patent Application No. 2024-212434 filed on Dec. 5, 2024, the entirety of which is incorporated herein by reference.

### TECHNICAL FIELD

The present disclosure relates to an optical modulator, a light source module, and an optical modulation method.

### BACKGROUND

XR glasses, such as AR (Augmented Reality) glasses and VR (Virtual Reality) glasses, are expected to become small wearable devices. The key to the widespread use of XR glasses is to miniaturize them so that each function fits into the size of a normal pair of glasses. In this situation, optical modulators that form optical waveguides using LN (lithium niobate) thin films as a material with electro-optical effects are expected.

It is known that LN thin film optical modulators suffer from a phenomenon called DC drift, in which the bias voltage-optical output characteristic shifts over time. Because the optical output changes over time due to the DC drift, there was a problem in that it was not easy to stabilize the output light at the desired intensity.

Japanese Patent No. 3881270 discloses a drive control device for an optical modulator equipped with an operating point control unit that detects the power of an optical signal output from the optical modulator and controls the operating point of the optical modulator based on the average value of the power of the optical signal. The technology disclosed in Japanese Patent No. 3881270 proposes a method of feedback-controlling the bias voltage based on the average value of the power of the output optical signal to compensate for the deviation of the operating point.

In the feedback control disclosed in Japanese Patent No. 3881270, the output of the optical modulator is sensed, and the bias voltage (control amount) is adjusted to correct the error with an appropriate value (target value). As recognized by the present inventors, the feedback control has the problem of delaying control because the error with respect to the target value is detected and then the error is corrected.

As also recognized by the present inventors, when DC drift occurs, which causes the optical output characteristics to become unstable in a short time, the feedback control creates a time lag and delays the control response, making it difficult to control the output to an appropriate value. In particular, in the modulation of visible light to express color, even a slight deviation in the output light has a significant effect on color reproducibility, so that there is a need to control the intensity of the output light with high precision.

### SUMMARY

One aspect of the present disclosure provides an optical modulator comprising: an optical modulation element in which a plurality of optical waveguides are formed on a thin film made of a material having an electro-optic effect; an electrode arranged on the thin film and applying an electric field to the plurality of optical waveguides; drive circuitry configured to apply a modulation voltage to the electrode; bias application circuitry configured to apply a bias voltage to the electrode; feedforward control circuitry configured to compensate for DC drift occurring in the plurality of optical waveguides; wherein the feedforward control circuitry changes the bias voltage output by the bias application circuitry over time based on a transfer function previously set in accordance with the characteristics of the DC drift.

One aspect of the present disclosure provides a light source module comprising the above optical modulator and a plurality of light sources each emitting visible light of a different wavelength.

One aspect of the present disclosure provides an optical modulation method for modulating light propagating through a plurality of optical waveguides using an optical modulator, the optical modulator including an optical modulation element in which a plurality of optical waveguides are formed in a thin film made of a material having an electro-optic effect, and an electrode for applying an electric field to the plurality of optical waveguides, the optical modulation method comprising: setting a transfer function in accordance with the characteristics of DC drift occurring in the plurality of optical waveguides, and calculating parameters of the transfer function; applying a modulation voltage and a bias voltage to the electrode to modulate the light propagating through the plurality of optical waveguides; and performing feedforward control to change the bias voltage over time based on the transfer function, thereby compensating for the DC drift occurring in the plurality of optical waveguides.

### BRIEF DESCRIPTION OF DRAWINGS

FIG. 1 is a schematic plan view of a light source module in a first embodiment of the present disclosure.

FIG. 2 is a diagram for explaining a Mach-Zehnder optical waveguide formed in the optical modulation element of the light source module shown in FIG. 1.

FIG. 3 is a cross-sectional view taken along line A-A in FIG. 2.

FIG. 4 is a block diagram for explaining the control function of the optical modulator shown in FIG. 2.

FIG. 5 is a diagram for explaining the concept of DC drift.

FIG. 6 is a conceptual diagram showing a drawing area on an image display surface, and an example of a scanning method.

FIG. 7 is a conceptual diagram showing a pattern of pixel voltages applied to one of multiple Mach-Zehnder optical waveguides on the vertical axis, with the horizontal axis representing time.

FIG. 8 is a conceptual diagram showing the arrangement of three consecutive pixels that form an image.

FIG. 9 is a diagram conceptually illustrating combinations of RGB pixel voltages for 1280 pixels in one row when the number of pixels in one image is “1280×720”.

FIG. 10 is a diagram for explaining the applied voltage width Vpp.

FIG. 11A is a graph schematically showing a change in applied voltage over time in the prior art.

FIG. 11B is a graph schematically showing a change in output light intensity over time in the prior art.

FIG. 12A is a graph schematically showing a change in the intensity of output light over time in the first embodiment of the present disclosure.

FIG. 12B is a graph schematically showing a change in applied voltage over time in the first embodiment of the present disclosure.

FIG. 13 is a diagram showing an equivalent circuit that models the cross-sectional structure of the optical modulation element shown in FIG. 3.

FIG. 14 is a diagram schematically showing the waveforms of the modulation voltage and bias voltage used in the optical modulator in the first embodiment of the present disclosure.

FIG. 15 is a flowchart showing an outline of the optical modulation method in the first embodiment of the present disclosure.

FIG. 16 is a flowchart showing an example of processing in the transfer function calculation process in the first embodiment of the present disclosure.

FIG. 17 is a flowchart showing an example of processing in feedforward control circuitry of the light source module in the first embodiment of the present disclosure.

FIG. 18 is a schematic plan view of the light source module in the second embodiment of the present disclosure.

FIG. 19 is a conceptual diagram for explaining XR glasses, which are an example of an image display device according to the present disclosure.

FIG. 20 is a conceptual diagram showing how an image is projected directly onto the retina by laser light emitted from the light source module in the XR glasses shown in FIG. 19.

### DETAILED DESCRIPTION

One aspect of the present disclosure provides an optical modulator, a light source module, and an optical modulation method capable of controlling the output light of the optical modulator at high speed and in a stable manner.

Hereinafter, the embodiments of the present disclosure will be described in detail with reference to the drawings as appropriate. The drawings used in the following description may show characteristic portions in an enlarged scale for the sake of clarity, and the dimensions and ratios of each component may differ from the actual dimensions. The materials, dimensions, etc. exemplified in the following description are merely examples. The present disclosure is not limited to these examples, and can be modified as appropriate within the scope of the effects of the present disclosure. In addition, the numerical range “X to Y” described in this specification means any numerical value in the range between X and Y.

### First Embodiment

The first embodiment of the present disclosure will be described hereinafter.

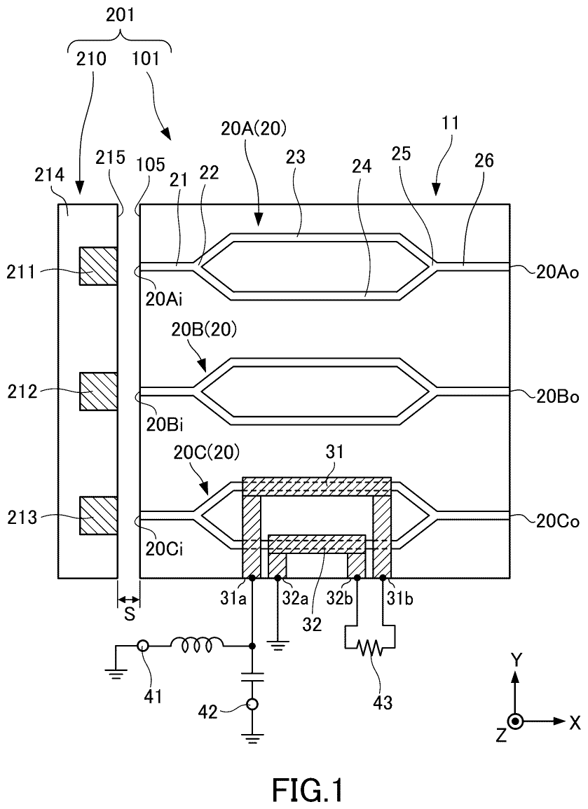

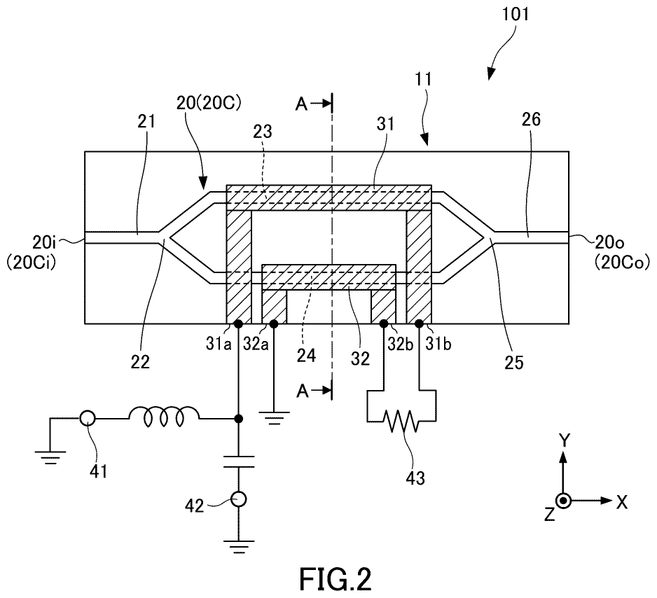

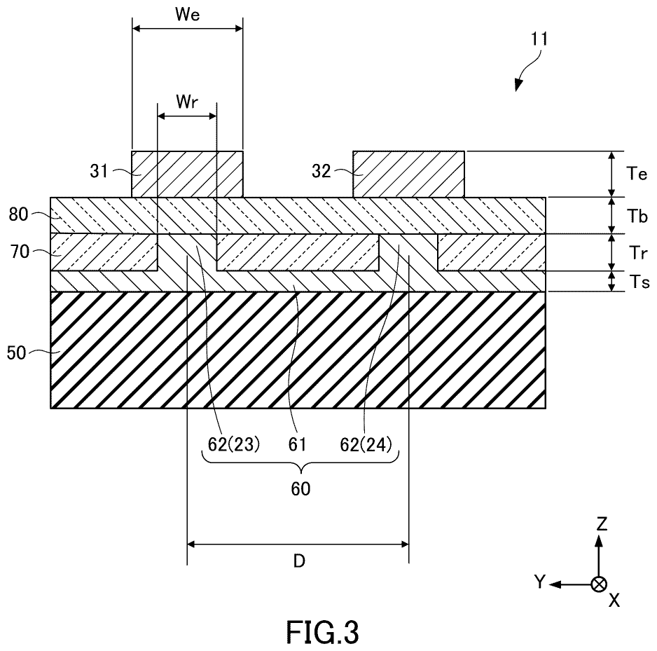

First, the configuration of a light source module 201 in the first embodiment of the present disclosure will be described with reference to FIGS. 1 to 3. FIG. 1 is a schematic plan view of the light source module 201 in the first embodiment. FIG. 2 is a diagram for explaining the Mach-Zehnder optical waveguide 20 formed in the optical modulation element 11 of the light source module 201 shown in FIG. 1. FIG. 3 is a cross-sectional view taken along line A-A in FIG. 2.

In this specification, the direction along one side of the optical modulation element 11 is the X direction, the direction perpendicular to the X direction is the Y direction, and the direction perpendicular to the X and Y directions is the Z direction. The X direction is the direction in which the first optical waveguide 23 and the second optical waveguide 24 formed in the optical modulation element 11 extend. The X direction corresponds to the longitudinal direction of the optical modulation element 11, and the Y direction corresponds to the width direction of the optical modulation element 11. The Z direction is perpendicular to the main surface of the optical modulation element 11. In the following, the +Z direction may be expressed as the upward direction, and the −Z direction as the downward direction. It should be noted that the Z direction, which is the upward and downward direction, does not necessarily coincide with the direction in which gravity acts.

The light source module 201 shown in FIG. 1 is configured to be equipped with a light source section 210 and an optical modulator 101.

The light source section 210 has a plurality of light sources 211, 212, and 213 arranged on a subcarrier 214. The plurality of light sources 211, 212, and 213 are light sources that emit visible light. The light source module 201 functions as a visible light source module.

The plurality of light sources 211, 212, and 213 may be, for example, laser diodes that emit red light (R), green light (G), blue light (B), etc. Here, laser diodes that emit three colors of visible light, red light, green light, and blue light, are provided as the multiple light sources 211, 212, and 213. Specifically, a laser diode that emits red light can be used as the light source 211, a laser diode that emits green light can be used as the light source 212, and a laser diode that emits blue light can be used as the light source 213. However, the arrangement order in which the light sources 211, 212, and 213 that emit each color is not particularly limited.

Light with a peak wavelength of 610 to 750 nm can be used for the red light. Light with a peak wavelength of 500 to 560 nm can be used for the green light. Light with a peak wavelength of 435 to 480 nm can be used for the blue light. Three light sources 211, 212, and 213 that emit the three primary colors (red, green, and blue) are arranged based on the principle of additive color mixing, but four or more light sources may be arranged. Also, a light source that emits light of a color other than the three primary colors may be used.

The light sources 211, 212, and 213 are spaced apart from each other in a direction approximately perpendicular to the direction of emission of the light emitted by each of the light sources 211, 212, and 213.

The light sources 211, 212, and 213 are fixed to the optical modulation element 11 constituting the optical modulator 101. The light sources 211, 212, and 213 are mounted on the upper surface of the subcarrier 214, for example, in the form of bare chips. The subcarrier 214 and the substrate 50 of the optical modulation element 11 are joined through a metal bonding layer or the like. When the light source module 201 is manufactured, the relative positions of the subcarrier 214 and the substrate 50 are adjusted, and the optical axis positions of the light sources 211, 212, and 213 can be adjusted by active alignment so that the optical axes of the light sources 211, 212, and 213 coincide with the axes of the input ports 20Ai, 20Bi, and 20Ci of the Mach-Zehnder optical waveguides 20A, 20B, and 20C.

In the light source module 201, the optical output surfaces 215 of the light sources 211, 212, and 213 and the optical input surface 105 of the optical modulator 101 are arranged to face each other. The optical output surface 215 and the optical input surface 105 are separated by a predetermined distance (spacing S in FIG. 1) to form a gap, which is filled with air. By setting the spacing S to be greater than 0 μm and equal to or less than 5 μm, light can be made to enter the input ports 20Ai, 20Bi, and 20Ci of the Mach-Zehnder optical waveguides 20A, 20B, and 20C while satisfying a predetermined coupling efficiency.

The optical modulator 101 has an optical modulation element 11 in which multiple Mach-Zehnder optical waveguides 20 (Mach-Zehnder optical waveguides 20A, 20B, and 20C) are formed. In FIG. 1, three Mach-Zehnder optical waveguides 20A, 20B, and 20C are formed in the optical modulation element 11, but four or more Mach-Zehnder optical waveguides may be formed depending on the number of light sources used.

The three Mach-Zehnder optical waveguides 20A, 20B, and 20C are provided corresponding to the three colors of visible light emitted by the three light sources 211, 212, and 213. The light input to the input ports 20Ai, 20Bi, and 20C of the Mach-Zehnder optical waveguides 20A, 20B, and 20C is modulated independently by each of the Mach-Zehnder optical waveguides 20A, 20B, and 20C.

The visible light of each wavelength is modulated by each Mach-Zehnder optical waveguide 20A, 20B, and 20C to a specific intensity ratio, and is output from three output ports 20Ao, 20Bo, and 20Co. The desired color can be expressed by overlapping these output lights. The output lights from each output port 20Ao, 20Bo, and 20Co may be supplied to an optical multiplexer and multiplexed into light that expresses a mixed color (intermediate color). Alternatively, the output lights of each wavelength may be appropriately overlapped without using an optical multiplexer so that they can be visually recognized as one mixed color.

The three Mach-Zehnder optical waveguides 20A, 20B, and 20C are provided on the same substrate 50 (see FIG. 3) and extend parallel to each other as a whole. By providing a plurality of Mach-Zehnder optical waveguides 20A, 20B, and 20C on the same substrate 50 in this way, miniaturization can be achieved. The Mach-Zehnder optical waveguides 20A, 20B, and 20C may be provided on different substrates.

A first electrode 31 and a second electrode 32 are arranged on each of the Mach-Zehnder optical waveguides 20A, 20B, and 20C. For the sake of simplicity, the first electrode 31 and the second electrode 32 are only drawn on the Mach-Zehnder optical waveguide 20C in FIG. 1, but the first electrode 31 and the second electrode 32 are similarly arranged on the other Mach-Zehnder optical waveguides 20A and 20B.

The optical modulation element 11 constituting the optical modulator 101 includes a Mach-Zehnder optical waveguide 20 formed above a substrate 50, a first electrode 31, and a second electrode 32. FIG. 2 and FIG. 3 show the vicinity of the Mach-Zehnder optical waveguide 20C formed in the optical modulation element 11, but the other Mach-Zehnder optical waveguides 20A and 20B have the same configuration. The input port 20i shown in FIG. 2 corresponds to the input ports 20Ai, 20Bi, and 20Ci of the Mach-Zehnder optical waveguides 20A, 20B, and 20C. The output port 200 shown in FIG. 2 corresponds to the output ports 20Ao, 20Bo, and 20Co of the Mach-Zehnder optical waveguides 20A, 20B, and 20C.

The Mach-Zehnder optical waveguide 20 is a Mach-Zehnder type optical waveguide having a Mach-Zehnder interferometer structure. One input optical waveguide 21 is branched into a first optical waveguide 23 and a second optical waveguide 24 by a branching section 22. The first optical waveguide 23 and the second optical waveguide 24 extend parallel to each other and are coupled to one output optical waveguide 26 by the multiplexing section 25. The light input from the input port 20i to the input optical waveguide 21 is split by the branching section 22 and modulated while traveling through the first optical waveguide 23 and the second optical waveguide 24. The light is then multiplexed by the multiplexing section 25 and travels through the output optical waveguide 26, and is output from the output port 200. The wavelength of the light modulated by the optical modulation element 11 is not particularly limited, but for example, visible light that can be seen by the human eye can be used.

The first electrode 31 and the second electrode 32 are electrodes for applying an electric field to the Mach-Zehnder optical waveguide 20. The first electrode 31 is disposed along the first optical waveguide 23, and the second electrode 32 is disposed along the second optical waveguide 24. The light traveling through the first optical waveguide 23 and the second optical waveguide 24 is modulated by the action of an electric field generated by the potential difference between the first electrode 31 and the second electrode 32.

The first electrode 31 and the second electrode 32 are disposed directly above the ridge portions 62 that respectively form the first optical waveguide 23 and the second optical waveguide 24. It should be noted that in FIG. 2, the length of the portion where the first electrode 31 and the first optical waveguide 23 overlap in the vertical direction is different from the length of the portion where the second electrode 32 and the second optical waveguide 24 overlap in the vertical direction, but in reality, these lengths are set to be approximately the same.

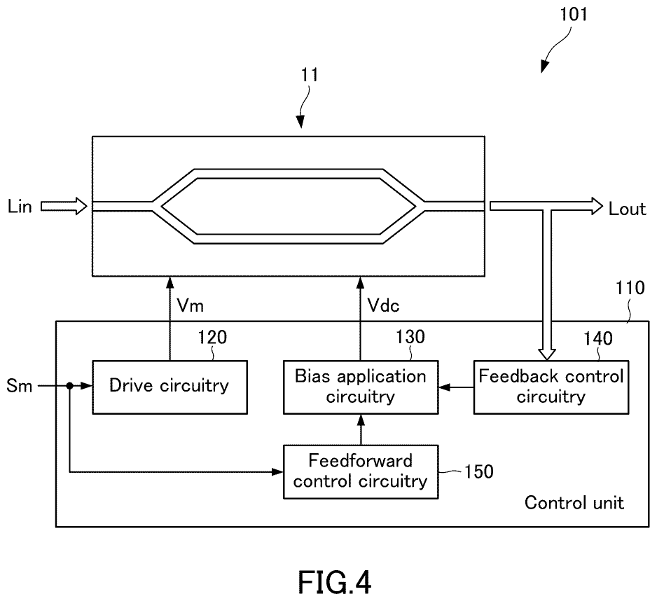

One end 31a of the first electrode 31 is connected to the first power source 41 and the second power source 42, and the other end 31b is connected to the termination resistor 43. One end 32a of the second electrode 32 is grounded, and the other end 32b is connected to the termination resistor 43. The first power source 41 constitutes a part of drive circuitry 120 (see FIG. 4) for applying a modulation voltage. The second power source 42 constitutes a part of bias application circuitry 130 (see FIG. 4) for applying a bias voltage.

In the configuration shown in FIG. 2, the modulation voltage and bias voltage are applied to the first electrode 31 and the second electrode 32 in a superimposed state. However, an electrode for the modulation voltage and an electrode for the bias voltage may be provided separately, and the modulation voltage and the bias voltage may be applied in different regions.

As shown in FIG. 3, the optical modulation element 11 has a multi-layer structure in which a ferroelectric thin film 60, a protective layer 70, and a buffer layer 80 are stacked in this order on a substrate 50. The first electrode 31 and the second electrode 32 are disposed on the buffer layer 80.

The ferroelectric thin film 60 is a ferroelectric thin film made of a crystal represented by the chemical formula ABX₃. The material of the ferroelectric thin film 60 can be a material having an electro-optic effect. As a material having an electro-optic effect, for example, a ferroelectric oxide such as lithium niobate (LiNbO₃), lithium tantalate (LiTaO₃), or barium titanate (BaTiO₃) can be used. The optical modulation element 11 using lithium niobate for the ferroelectric thin film 60 is sometimes called an LN optical modulation element, and the optical modulator 101 in which the LN optical modulation element is implemented is sometimes called an LN optical modulator.

As shown in FIG. 3, the ferroelectric thin film 60 is composed of a slab layer 61 having a predetermined thickness and a ridge portion 62 protruding from the upper surface of the slab layer 61. The ridge portion 62 can confine light therein and form an optical waveguide that propagates the light.

The ridge portion 62 is provided at a position where the Mach-Zehnder optical waveguide 20 is to be formed. As shown in FIG. 3, the first optical waveguide 23 and the second optical waveguide 24 are formed at the position where the ridge portion 62 is provided. The ridge portion 62 may be a protruding portion formed by etching the ferroelectric thin film 60, or may be formed by attaching the same material as the ferroelectric thin film 60 to the upper surface of the ferroelectric thin film 60. The shape of the ridge portion 62 is not particularly limited, and the cross section may be rectangular or dome-shaped.

The thickness of the slab layer 61 (thickness Ts in FIG. 3) is advantageously, for example, 0.1 to 0.3 μm. If the optical waveguide formed by the ridge portion 62 is too small, light does not propagate properly, and if it is too large, the propagating light becomes multi-mode. For this reason, the thickness of the ridge portion 62 (thickness Tr in FIG. 3) is advantageously, for example, 0.5 to 1.0 μm, and the width of the upper surface of the ridge portion 62 (width Wr in FIG. 3) is advantageously 0.3 to 1.2 μm.

By reducing the distance between adjacent ridge portions 62, the electric field efficiency of the optical waveguides formed by the ridge portions 62 can be improved. The distance between the centers of the adjacent ridge portions 62 (distance D in FIG. 3) is advantageously, for example, 2 to 12 μm.

Instead of forming an optical waveguide by the ridge portions 62, an optical waveguide may be formed by providing a region with a high refractive index in the ferroelectric thin film 60. For example, a region with a high refractive index may be created locally in the ferroelectric thin film 60 by Ti diffusion method or proton exchange method, and this region may be used as the optical waveguide.

The substrate 50 is not particularly limited as long as it has a lower refractive index than the ferroelectric thin film 60, but is advantageously a substrate on which the ferroelectric thin film 60 can be formed as an epitaxial film with excellent crystallinity. For example, a sapphire substrate, a silicon single crystal substrate, a thermally oxidized silicon substrate, or the like can be used as the substrate 50.

The crystal orientation of the substrate 50 is not particularly limited, but since it serves as a base for the ferroelectric thin film 60, it is advantageous that the substrate 50 has the same symmetry as the ferroelectric thin film 60. Specifically, a lithium niobate film has three-fold symmetry, and when a c-axis oriented lithium niobate film is used as the ferroelectric thin film 60, it is advantageous to use a substrate 50 with a c-plane for a sapphire single crystal substrate, or a (111) plane for a silicon single crystal substrate.

An epitaxial film is a film in which crystals grow based on the crystal orientation of the underlying substrate 50, and are oriented in a specific crystal orientation in accordance with the crystal structure of the substrate 50. Whether the ferroelectric thin film 60 is an epitaxial film relative to the substrate 50 can be proven, for example, by performing peak intensity and pole analysis at the orientation position in 2θ-θ X-ray diffraction.

Specifically, when a measurement is performed using 2θ-θ X-ray diffraction, all peak intensities other than the target plane must be 10% or less, advantageously 5% or less, of the maximum peak intensity of the target plane. For example, in the case of an epitaxial film made of a c-axis oriented lithium niobate film, the peak intensity of planes other than the (00L) plane is 10% or less, advantageously 5% or less, of the maximum peak intensity of the (00L) plane. Here, (00L) is a general designation for equivalent planes such as (001) and (002).

It is also necessary to observe the poles in the pole analysis. Confirming the peak intensity at a specific orientation position is merely evaluating the crystal orientation in one direction only. Therefore, even if it is confirmed that the peak intensity is below a predetermined value, if the crystal orientation is not aligned within the plane, the intensity of the X-rays will not increase at a specific angle position and the poles will not be observed. Since LiNbO₃ has a trigonal crystal structure, there are three poles of LiNbO₃ (014) in a single crystal.

It is known that lithium niobate films grow epitaxially in a twin state, in which crystals rotated 180° around the c-axis are symmetrically bonded. In this case, two of the three poles are symmetrically bonded, so that six poles are observed. In addition, when a lithium niobate film is formed on a silicon single crystal substrate with a (100) surface, the substrate is four-fold symmetric, so that 4×3=12 poles are observed. In the present disclosure, lithium niobate films that grow epitaxially in a twin state are also included in the epitaxial film.

The composition of lithium niobate is LiₓNbA_{y}O_{z}. x is 0.5 to 1.2, and advantageously 0.9 to 1.05. y is 0 to 0.5. z is 1.5 to 4.0, and advantageously 2.5 to 3.5. The element A is an element other than Li, Nb, and O. The element A include, for example, K, Na, Rb, Cs, Be, Mg, Ca, Sr, Ba, Ti, Zr, Hf, V, Cr, Mo, W, Fe, Co, Ni, Zn, Sc, Ce, etc., and may be a combination of two or more of these elements.

The ferroelectric thin film 60 is not limited to one formed by epitaxial growth, and may be a thin film bonded to the upper surface of the substrate 50.

As shown in FIG. 3, the protective layer 70 is disposed between the slab layer 61 of the ferroelectric thin film 60 and the buffer layer 80. In FIG. 3, the protective layer 70 is disposed so as to fill the gap between adjacent ridge portions 62 and cover the upper surface of the slab layer 61 and the side surface of the ridge portions 62.

The protective layer 70 is made of a dielectric material having a smaller refractive index than the ferroelectric thin film 60. The material of the protective layer 70 may be, for example, silicon oxide (SiO₂), aluminum oxide (Al₂O₃), lanthanum oxide (La₂O₃), or a composite of these oxides. An example of the composite of oxides is LaAlSiInO. Of the above, it is advantageous to use silicon oxide as the material of the protective layer 70.

The buffer layer 80 is formed on the ferroelectric thin film 60 and the protective layer 70. In the configuration shown in FIG. 3, the protective layer 70 is filled between the adjacent ridge portions 62, and the buffer layer 80 is disposed so as to cover the upper surface of the protective layer 70 and the upper surface of the ridge portions 62. The buffer layer 80 has a role of preventing visible light propagating through the ferroelectric thin film 60 from being absorbed by the first electrode 31 and the second electrode 32.

The buffer layer 80 is made of a dielectric material having a smaller refractive index than the ferroelectric thin film 60. The dielectric material constituting the buffer layer 80 advantageously has a dielectric constant of 7 or more, which can reduce the electric field efficiency VπL (an index representing the electric field efficiency). Here, Vπ is the half-wave voltage, and is defined as the difference between the voltage V1 at which the optical output of the optical modulation element 11 is at its maximum and the voltage V2 at which it is at its minimum. VπL is the product of the half-wave voltage Vπ and the electrode length L, and the smaller VπL is, the more compact the device can be and the lower the drive voltage can be.

The material of the dielectric constituting the buffer layer 80 may be aluminum oxide (dielectric constant 7), LaAlSiInO (dielectric constant 11), etc. The material of the buffer layer 80 may be the same as that of the protective layer 70, or may be a material different from that of the protective layer 70. When the protective layer 70 and the buffer layer 80 are made of the same material, the protective layer 70 and the buffer layer 80 can be formed as an integrated layer.

The thickness of the buffer layer 80 (thickness Tb in FIG. 3) is advantageously 0.4 to 1.0 μm, which can reduce the electric field efficiency VπL.

The first electrode 31 and the second electrode 32 are disposed on the upper surface of the buffer layer 80. The material of the first electrode 31 and the second electrode 32 is a metal material with high electrical conductivity, and it is advantageous to use, for example, Au, Cu, Ag, Pt, etc. The width of the first electrode 31 and the second electrode 32 (width We in FIG. 3) is advantageously 1.0 to 4.0 μm, which can reduce the electric field efficiency VπL. The thickness of the first electrode 31 and the second electrode 32 (thickness Te in FIG. 3) is advantageously 0.1 to 5.0 μm, which can efficiently transmit the high-frequency modulation voltage.

Here, the ferroelectric thin film 60 is a Z-cut lithium niobate film. The Z-cut lithium niobate film exhibits a strong electro-optic effect in the Z direction in the drawings of this application. For this reason, as shown in FIG. 3, the first electrode 31 and the second electrode 32 are advantageously disposed directly above the ridge portions 62 that form the first optical waveguide 23 and the second optical waveguide 24, respectively. An electric field generated between the first electrode 31 and the second electrode 32 is applied to each of the first optical waveguide 23 and the second optical waveguide 24. An asymmetric electric field is applied to the first optical waveguide 23 and the second optical waveguide 24, with the top and bottom directions being reversed. The refractive indexes of the first optical waveguide 23 and the second optical waveguide 24 change to +Δn and −Δn, respectively, due to the action of the electric field, and the phase difference of the light traveling through each optical waveguide changes. The light modulated by this change in phase difference is multiplexed in the multiplexing section 25 and output from the output port 200.

However, an X-cut lithium niobate film may be used for the ferroelectric thin film 60. In this case, it is advantageous that the electro-optic effect is strongly expressed in the Y direction in the drawings of this application, and that the first electrode 31 and the second electrode 32 are disposed on the sides of the ridge portions 62 that forms the first optical waveguide 23 and the second optical waveguide 24.

The voltage control related to the optical modulator 101 will be described with reference to FIG. 4. FIG. 4 is a block diagram for explaining the voltage control function related to the optical modulator 101 shown in FIG. 2. The optical modulator 101 has an optical modulation element 11 and a control unit 110 electrically connected to the optical modulation element 11.

As shown in FIG. 4, the optical modulation element 11 converts the input light Lin into an output light Lout in accordance with a modulation signal Sm. This makes it possible to convert the modulation signal Sm, which is an electrical signal, into an optical signal.

The control unit 110 has a function of controlling the voltage applied to the Mach-Zehnder optical waveguide 20 of the optical modulation element 11. As shown in FIG. 4, the control unit 110 has drive circuitry 120, bias application circuitry 130, feedback control circuitry 140, and feedforward control circuitry 150.

The drive circuitry 120 is circuitry that supplies a modulation voltage Vm in accordance with the modulation signal Sm to the first electrode 31 and the second electrode 32. The drive circuitry 120 includes a first power source 41 (see FIG. 1) that generates the modulation voltage Vm. Modulation signal generating circuitry (not shown) that generates a modulation signal Sm is connected to the drive circuitry 120. The modulation signal Sm is a signal for carrying information on the light traveling through the Mach-Zehnder optical waveguide 20. The modulation voltage Vm has a voltage value corresponding to the modulation signal Sm. The drive circuitry 120 constitutes the drive unit of the present disclosure.

The bias application circuitry 130 is circuitry that applies a bias voltage Vdc to the first electrode 31 and the second electrode 32. The bias application circuitry 130 outputs the bias voltage Vdc under feedback control by the feedback control circuitry 140. The bias application circuitry 130 also outputs the bias voltage Vdc under feedforward control by the feedforward control circuitry 150. The bias application circuitry 130 constitutes the bias application unit of the present disclosure.

The bias application circuitry 130 includes a second power source 42 (see FIG. 1) that generates the bias voltage Vdc. An electric field corresponding to the bias voltage Vdc is generated between the first electrode 31 and the second electrode 32, and changes the refractive index of the ridge portions 62 that form the first optical waveguide 23 and the second optical waveguide 24. The bias voltage Vdc is a DC voltage applied to adjust the operating point. The operating point is the voltage at the center of the modulation voltage amplitude, and by setting an appropriate operating point, it is possible to perform accurate optical modulation and improve signal quality.

In this embodiment, the modulation voltage Vm and the bias voltage Vdc are applied to the same electrode (the first electrode 31 and the second electrode 32). In this case, the bias voltage Vdc and the modulation voltage Vm are applied to the first electrode 31 and the second electrode 32 in a superimposed state. However, the modulation voltage Vm may be applied to the electrode for the modulation voltage, and the bias voltage Vdc may be applied to the electrode for the bias voltage. In this specification, the voltage obtained by superimposing the bias voltage Vdc and the modulation voltage Vm may be referred to as the applied voltage.

The feedback control circuitry 140 is a circuitry that monitors the output light Lout, and based on the monitoring results, performs feedback control of the bias voltage Vdc output by the bias application circuitry 130. The operating point is controlled by adjusting this bias voltage Vdc. The feedback control circuitry 140 does not necessarily have to be provided.

The feedforward control circuitry 150 is circuitry that performs the feedforward control of the bias voltage Vdc output by the bias application circuitry 130 based on a transfer function obtained in advance. The feedforward control predicts the behavior of the controlled object in advance, and controls in a direction that suppresses the effects of undesirable unstable behavior in advance, and is more responsive than the feedback control. A transfer function corresponding to the DC drift characteristics of the first optical waveguide 23 and the second optical waveguide 24 is set in the feedforward control circuitry 150. The feedforward control circuitry 150 constitutes the feedforward control unit of the present disclosure.

The feedforward control circuitry 150 outputs a voltage value calculated from the transfer function to the bias application circuitry 130. The bias application circuitry 130 outputs a bias voltage Vdc corresponding to this voltage value. As will be described later, the transfer function has a voltage change profile that monotonically increases the bias voltage over time.

The feedforward control circuitry 150 is also supplied with a modulation signal Sm. The feedforward control circuitry 150 detects a change in the modulation voltage Vm based on, for example, the modulation signal Sm. The change in the modulation voltage Vm here means a change in the modulation voltage level (the intensity of the modulation voltage Vm). When a change in the modulation voltage Vm is detected, the feedforward control circuitry 150 is configured to reset the voltage value that monotonically increases over time to an initial value, and then to monotonically increase it again from the initial value.

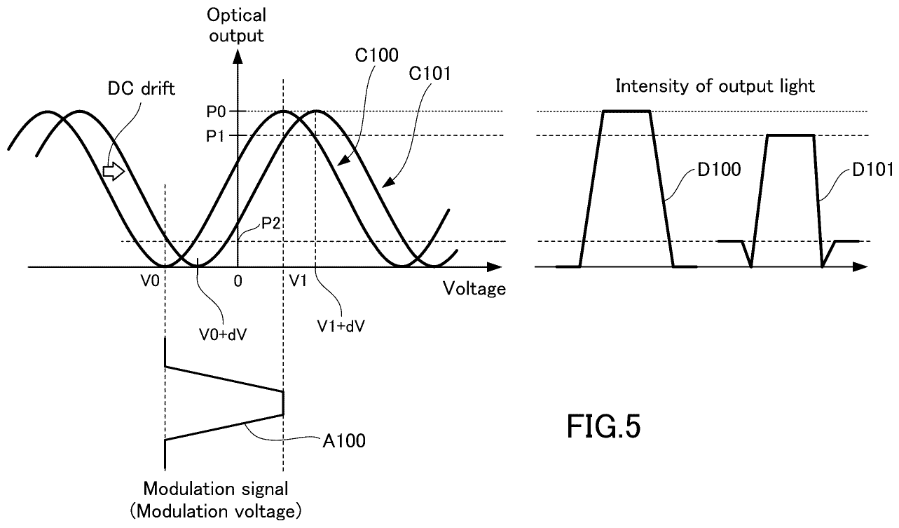

The concept of DC drift will be explained. FIG. 5 is a diagram for explaining the concept of DC drift. FIG. 5 shows a case where the modulation curve of the optical modulator 101 moves to the positive side due to DC drift caused by a positive bias voltage.

Each optical modulator 101 has its own modulation curve (operating characteristic curve). In the optical modulator 101, the input light is modulated by the modulation voltage Vm applied corresponding to this modulation curve, and the modulated light is output as an output optical signal.

It is known that the optical modulator 101 has a phenomenon in which the modulation curve shifts over time (DC drift). The DC drift is a phenomenon in which the direct current component of the voltage applied to the optical modulator 101 fluctuates unintentionally, and occurs due to various factors such as temperature change, change over time, or unstable behavior when voltage is applied.

The modulation curve of the optical modulator 101 is expressed as the intensity of the output light (optical output intensity) periodically increasing and decreasing with increasing applied voltage. FIG. 5 shows a modulation curve C100 when no DC drift occurs, and a modulation curve C101 when a DC drift occurs. In addition, a modulation signal (modulation voltage) A100, an output optical signal D100 when no DC drift occurs, and an output optical signal D101 when a DC drift occurs are also shown.

In FIG. 5, as shown by the modulation curve C100, the minimum (0) and maximum (P0) values of the optical output corresponding to the input signal are obtained when the voltages V0 and V1 are applied, respectively. In other word, in the case of no DC drift occurring, the intensity of the output light becomes the minimum (0) when the voltage V0 is applied, and the intensity of the output light becomes the maximum (P0) when the voltage V1 is applied. The bias voltage is usually adjusted to have the midpoint between the voltages V0 and V1 be the operating point.

On the other hand, when DC drift occurs, the modulation curve shifts in the bias voltage direction to become the modulation curve C101. When the voltages V0 and V1 that indicate the minimum and maximum values of the optical output are fixed, the intensity of the output light at the voltages V0 and V1 becomes the voltages P2 and P1, respectively, due to the periodicity of the modulation curve. The intensity of the output light corresponds to, for example, 8-bit gradation (256 gradations). Even a slight error in the intensity of the output light will result in an output light with a different gradation.

Let us assume that the amount of shift (drift amount) from modulation curve C100 to modulation curve C101 is +dV. In this case, for example, by changing voltage V0 and voltage V1 to voltage (V0+dV) and voltage (V1+dV), respectively, the light output before the occurrence of DC drift can be maintained. Further, while FIG. 5 shows the DC drift caused by a positive bias voltage, the DC drift of a negative bias voltage moves to the negative side.

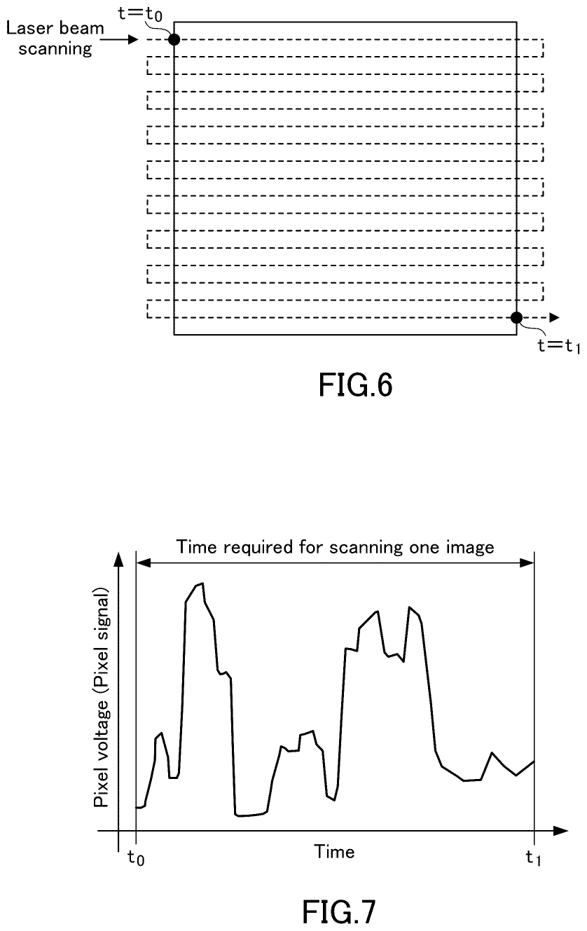

An example of a laser beam scanning method will be described with reference to FIG. 6 and FIG. 7.

FIG. 6 shows a drawing area on an image display surface, and is a conceptual diagram showing an example of a scanning method when an image is displayed by changing the intensity (color tone) of the output light for each pixel while scanning a laser beam using an image display device equipped with the optical modulator 101 of this embodiment. FIG. 7 is a conceptual diagram showing the pattern of pixel voltages (pixel signals) applied to one of the multiple Mach-Zehnder optical waveguides 20A, 20B, and 20C on the vertical axis, with the horizontal axis representing time.

As shown in FIG. 6, a single image is formed by sequentially scanning the laser beam. The start time of scanning for displaying one image is t0, and the end time of scanning is t1.

The arrows in FIG. 6 indicate the scanning direction of the laser beam, and the laser beam scans one pixel at a time in the horizontal direction from left to right. When it reaches the right end, it moves down one row vertically and scans one pixel at a time horizontally from right to left, and when it reaches the left end, it moves down one row vertically and scans one pixel at a time horizontally from left to right. By repeating such scanning, the entire image is displayed. Here, the raster scan scanning method is explained as an example, but scanning methods such as vector scan and Lissajous scan, which scan one pixel at a time, may also be used.

As the laser beam moves through each dot (pixel) of the image, the color of the laser changes over time. It takes a certain amount of time to form one image, but because this is too fast for the human eye to keep up with, it is perceived as one image. The scanning speed of the laser beam is generally around 100 to 500 MHz (a speed at which the entire image changes 60 times per second).

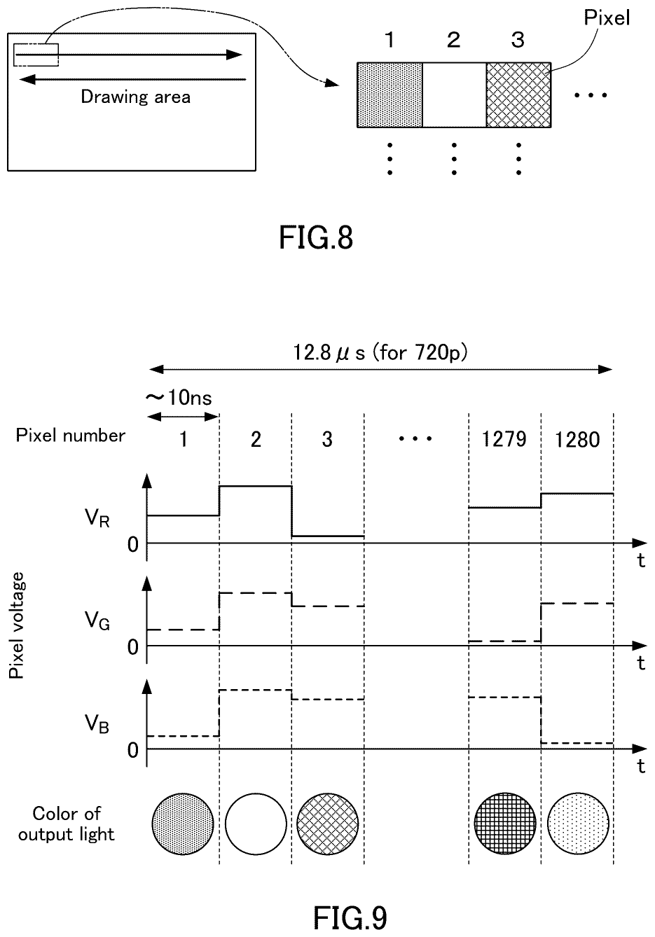

FIG. 8 is a conceptual diagram showing the arrangement of three consecutive pixels that form an image. The color displayed by each pixel is determined by the combination of the intensity of the output light of the three colors red (R), green (G), and blue (B).

The color tone can be changed by changing the intensity of the output light of the three primary colors of light, i.e., red (R), green (G), and blue (B). For example, if the output light intensity of each color is changed using 8 bits of red, 8 bits of green, and 8 bits of blue, a combination of these can represent 24-bit color tones (approximately 16.77 million colors) (24-bit color system). In the 24-bit color system, each RGB color has 8 bits of information, and each can be reproduced in 256 gradations. There are voltage values ranging from 0 to 255 for each RGB color. For example, when all RGB are 0, the result is black, and when all are 255, the result is white.

FIG. 9 is a diagram conceptually illustrating the combination of RGB pixel voltages (pixel signals) for each of 1280 pixels in one row when the number of pixels in an image is “1280×720”. In FIG. 9, pixel numbers 1 to 1280 are assigned to the 1280 pixels that form one row in the horizontal direction of the image. In raster scanning, each pixel (pixel number 1 to 1280) lined up in the horizontal direction is scanned while appropriately setting the intensity of the output light of the three colors red (R), green (G), and blue (B), and the scanning is then repeated with each pixel shifted vertically, so that it is possible to display the entire image. When the drawing time of one pixel is 10 ns (nanoseconds), the time required for scanning one row is 12.8 μs (microseconds), and the time required for displaying one screen is approximately 10 ms (milliseconds).

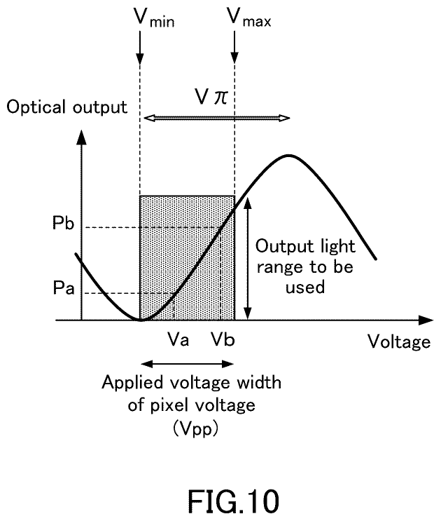

FIG. 10 is a diagram for explaining the width of the applied voltage (applied voltage width Vpp) applied to the optical modulator 101. The applied voltage width Vpp is the voltage range used when performing optical modulation in the Mach-Zehnder optical waveguide 20. When the minimum and maximum values of the applied voltage are the minimum voltage Vₘᵢₙ and the maximum voltage Vₘₐₓ, respectively, the applied voltage width Vpp is expressed as Vₘₐₓ−Vₘᵢₙ, and the operating point is set to the midpoint of the applied voltage width Vpp. In the optical modulator 101, a modulation voltage is applied within the range of the applied voltage width Vpp, and the intensity of the output light changes in response to the modulation voltage. As an example as shown in FIG. 10, when a modulation voltage Va is applied, light with intensity Pa is output, and when a modulation voltage Vb is applied, light with intensity Pb is output. The magnitude of the applied voltage width Vpp may be a half-wave voltage Vπ, or may be smaller than the half-wave voltage Vπ as shown in FIG. 10 to reduce power consumption.

In the light source module 201 of this embodiment, the color tone of each pixel is expressed by finely adjusting the intensity of the three colors of visible light emitted by the three light sources 211, 212, and 213. In the 24-bit color system, the intensity of the light emitted by the three light sources 211, 212, and 213 must be changed to an appropriate level out of 256 levels, and even a slight deviation in the intensity of the output light has a large effect on color reproducibility and may be visually recognized as a different color. For example, when compared to optical modulation based on a binary signal, the modulation of visible light that expresses colors requires more precise intensity control.

The present disclosure compensates for the DC drift that occurs when changing the applied voltage value to the Mach-Zehnder optical waveguide 20 in particular, and modulates the light to an appropriate intensity (tone). The DC drift that is the subject of the present disclosure makes the optical output characteristics unstable in a short time, and changes the intensity of the output light over time. In addition, there is also the problem that the time constant of the DC drift in visible light is smaller than that of light in the wavelength band used in optical communication, etc., and the change in the DC drift over time is also faster. By compensating for this DC drift, it is possible to suppress unintended changes in the output light and realize the high-precision optical modulation required for the modulation of visible light. The time constant of the DC drift in visible light is about several hundred milliseconds to several seconds.

As described above, the optical modulator 101 shown in FIG. 4 includes a feedforward control circuitry 150. The feedforward control circuitry 150 applies an appropriate bias voltage to cancel the DC drift that occurs with the change in the modulation voltage, thereby stabilizing the unstable behavior that occurs accompanied by the change in the applied voltage.

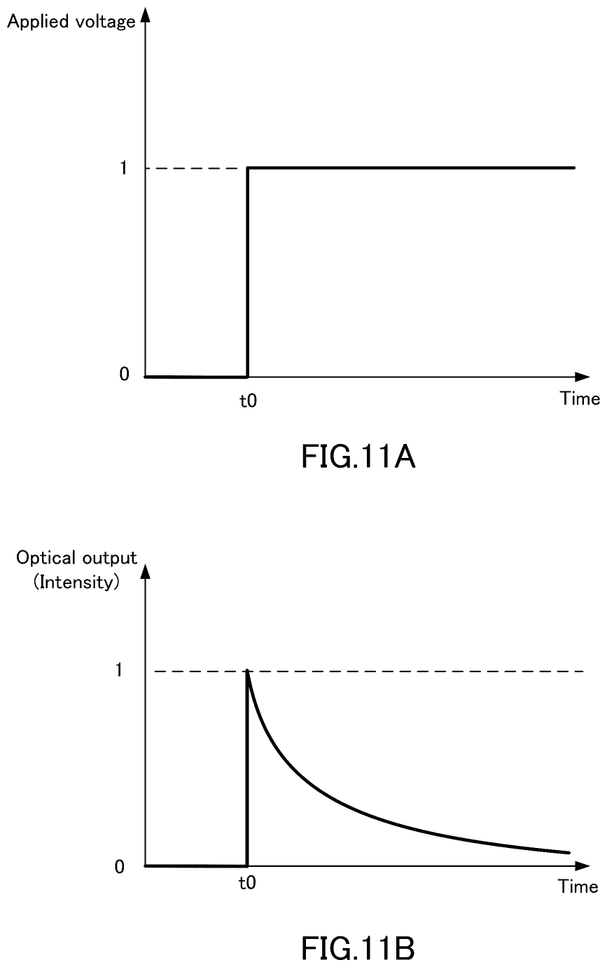

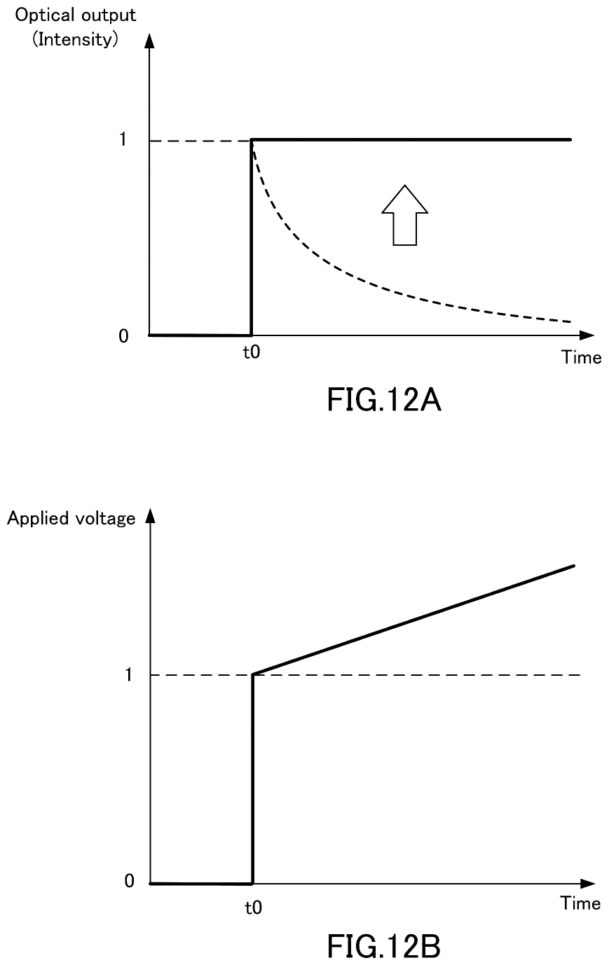

The relationship between the applied voltage and the intensity of the output light will be described hereinafter. FIGS. 11A and 11B schematically show respective diagrams of the relationship between the applied voltage and the intensity of the output light in the prior art. FIG. 11A is a graph schematically showing a change in applied voltage over time in the prior art, and FIG. 11B is a graph schematically showing a change in the intensity of output light over time in the prior art. FIGS. 12A and 12B schematically show the relationship between applied voltage and intensity of output light according to the present disclosure. FIG. 12A is a graph schematically showing a change in the intensity of output light over time according to the present embodiment, and FIG. 12B is a graph schematically showing a change in applied voltage over time according to the present embodiment. It should be noted that the graphs in FIGS. 11A, 11B, 12A, and 12B are intended to explain the tendency of change over time, and the values of applied voltage and intensity of output light (values 0 and 1) in the graphs do not represent actual values.

As shown in FIG. 11A, it is assumed that the applied voltage changes from value 0 to value 1 at time t0. At this time, as shown in FIG. 11B, the intensity of the output light changes instantaneously in response to the change in the applied voltage at time to, but then the phenomenon of exponentially decreasing toward a predetermined value (for example, the value before the change) occurs. This phenomenon is due to a short-term DC drift caused by the change in the applied voltage, and it is considered that the intensity of the output light decreases as the modulation curve (operating characteristic curve) shifts due to the DC drift.

In this embodiment, the feedforward control is adopted to quickly stabilize the intensity of the output light after the applied voltage is changed. In the feedforward control, the DC drift that occurs after the change in the modulation voltage is compensated for by appropriately adjusting the bias voltage included in the applied voltage.

As shown in FIG. 12A, it is desired to maintain the desired intensity by compensating for the decrease in the intensity of the output light that occurs after time to (in the direction of the arrow in FIG. 12A). In order to maintain the intensity of the output light, which decreases exponentially, the applied voltage is feedforward controlled using a voltage change profile (transfer function) set to suppress the effect of the DC drift. As this voltage change profile, one that monotonically increases the bias voltage can be used. Advantageously, as shown in FIG. 12B, a voltage change profile may be used in which the applied voltage is linearly increased at a constant rate over time. This makes it possible for the applied voltage behavior to compensate for the decrease in the intensity of the output light, and to maintain the intensity of the output light close to the desired value.

The transfer function set in the feedforward control circuitry 150 will be explained hereinafter.

In feedforward control, F(s) is set so that F(s)·G(s)=1. Here, F(s) is the transfer function of the feedforward control circuitry 150, and G(s) is the transfer function of the controlled object. In the optical modulator 101 of this embodiment, F(s) is a transfer function that indicates the characteristics of the input voltage that stabilizes the intensity of the output light, and G(s) is a transfer function that indicates the intensity of the output light actually obtained in the optical modulator 101 relative to the input voltage.

G(s), which is the transfer function of the controlled object, has the characteristic that the intensity of the output light changes instantaneously and then drops exponentially for an input voltage described by a step function, as shown in FIG. 11B. In order to keep the intensity of the output light, which is the output of G(s), constant, it is effective to appropriately set F(s), which is the transfer function of the feedforward control circuitry 150, to compensate for the voltage drop due to DC drift. By setting F(s) so that an input voltage that compensates for the voltage drop due to DC drift is supplied to G(s), F(s)·G(s) can be made to approach 1.

It is advantageous to set a transfer function for F(s) that increases the voltage value after time t0 when the input voltage changes for an input voltage that can be described by a step function u(t). A specific example of setting the transfer function F(s) will be described hereinafter.

According to the output light intensity with respect to the input voltage shown in FIG. 11B, it can be seen that G(S) has a differential characteristic that responds instantly to changes in the input voltage, and a delay characteristic that changes exponentially. In other words, the transfer function G(s) of the optical modulator 101, which is the actual system, can be described as a function such as G(s)=s/(s+a), which combines the differential characteristic and the delay characteristic, or G(s)=(s+b)/(s+a), which further takes offset into account.

Here, as shown in the following equations, the step response is considered when a step function u(t) is input to a system with a transfer function G(s)=s/(s+a). The Laplace transform U(s) of the step function u(t) is 1/s. The Laplace transform Y(s) of the output y(t) is expressed as the product of the transfer function G(s) and the input U(s). When an inverse Laplace transform is performed on this Y(s), it is found that the output y(t) is exp(−at). This approximately represents the response characteristics of the actual optical modulator 101.

Consider the step response for

$$G ( s ) = \frac{s}{s + a}$$

$$Let$$

$$ℒ \{ u ( t ) \} = \frac{1}{s}$$

be the Laplace transform of the step function.

Then,

$$Y ( s ) = G ( s ) ℒ \{ u ( t ) \} = \frac{s}{s + a} \cdot \frac{1}{s} = \frac{1}{s + a}$$

Taking the inverse Laplace transform gives

$${ℒ}^{- 1} \{ Y ( s ) \} = {e}^{- a t}$$

The transfer function F(s) of the feedforward control circuitry 150 may be set such that F(s)·G(s)=1 is obtained, and may therefore be given F(s)=G⁻¹(s)=(s+a)/s.

Here, the step response is considered when a step function u(t) is input to a system with a transfer function F(s)=(s+a)/s, as shown in the following equations. The Laplace transform U(s) of the step function u(t) is 1/s, and the Laplace transform Y(s) of the output is expressed as the product of the transfer function F(s) and the input U(s). When an inverse Laplace transform is performed on this Y(s), it is found that the output y(t) is 1+at. This means that the output y(t) increases linearly over time.

Consider the step response for

$$F ( s ) = \frac{s + a}{s} = 1 + \frac{a}{s}$$

$$Let$$

$$ℒ \{ u ( t ) \} = \frac{1}{s}$$

be the Laplace transform of the step function.

Then,

$$Y ( s ) = F ( s ) ℒ \{ u ( t ) \} = \frac{1}{s} \cdot \frac{s + a}{s} = \frac{1}{s} + \frac{a}{{s}^{2}}$$

Consider the inverse Laplace transform of the above.

Since

$${ℒ}^{- 1} \{ \frac{a}{{s}^{2}} \} = α t , {ℒ}^{- 1} \{ \frac{1}{s} \} = 1$$

it follows that

$${ℒ}^{- 1} \{ Y ( s ) \} = 1 + at$$

As described above, the intensity of the output light of a real system having a transfer function G(s) decreases over time, thereby leading to monotonically increasing the input voltage over time, so that it is possible to mitigate the decrease in the intensity of the output light over time. The input voltage may be set to increase monotonically over time. It is advantageous to set the transfer function set in the feedforward control circuitry 150 to a linear function that increases linearly over time.

Hereinafter, explanation will be made about a method for setting the parameters of the transfer function implemented in the feedforward control circuitry 150.

The parameters of the transfer function implemented in the feedforward control circuitry 150 can be specified, for example, by inputting a test signal to the optical modulator 101. Specifically, a sinusoidal test signal is input to the optical modulator 101 to measure the response, so that the transfer function parameters can be determined by applying the mathematical technique represented by the following equations.

### Response Characteristics of DC Drift

$${v}_{o} ( t ) = - A {e}^{- α t} - {Be}^{- β t} + C \qquad [ 1 ]$$

$${V}_{o} ( s ) = - \frac{A}{s + α} - \frac{B}{s + β} + \frac{C}{s} \qquad [ 2 ]$$

$$Sinusoidal Wave$$

$${V}_{i} ( s ) = \frac{{V}_{m} ω}{{S}^{2} + {ω}^{2}} , ω = 2 π f \qquad [ 3 ]$$

### Frequency Response to Sinusoidal Input

### Amplitude Response

$$\vert H ( j ω ) ) \vert = [ - \frac{jC}{ω} - \frac{Aj ω}{j ω + α} - \frac{Bj ω}{j ω + β} ] \qquad [ 4 ]$$

$$Phase Response$$

$$arg \vert H ( j ω ) \vert = arg ( - \frac{jC}{ω} ) + arg ( - \frac{Aj ω}{j ω + α} ) + arg ( - \frac{Bj ω}{j ω + β} ) \qquad [ 5 ]$$

Equation [1] represents the DC drift characteristics of the optical modulator 101. When a Z-cut lithium niobate film is used for the optical modulator 101, an asymmetric electric field is applied to the first optical waveguide 23 and the second optical waveguide 24. The first and second terms on the right side of Equation [1] represent the exponential decay (transient response) of these two optical waveguides, and the third term on the right side represents a stationary term. Further, when an X-cut lithium niobate film is used for the optical modulator 101, it is considered that a similar electric field is applied to the first optical waveguide 23 and the second optical waveguide 24, and the first and second terms on the right side of Equation [1] can be combined into a single exponential decay term.

Equation [2] is the Laplace transform of Equation [1], and Equation [3] is the Laplace transform of the sine wave used as the test signal. Here, ω is the frequency of the sine wave.

The frequency response when a sine wave test signal is input to the optical modulator 101 is evaluated using the transfer function H(s). Here, the transfer function H(s) shows the characteristics of the response (Equation [2]) to the sine wave input (Equation [3]).

The transfer function H(s) includes the amplitude response and the phase response. Equation [4] shows the amplitude response to a sinusoidal wave with frequency ω, and Equation [5] shows the phase response to a sinusoidal wave with frequency ω.

The unknown parameters (parameters A, B, C, α, and β) included in Equation [1] can be simultaneously found by inputting a sinusoidal test signal to the optical modulator 101 multiple times and measuring the amplitude change and the phase shift of the output relative to the input with an oscilloscope or the like. Since there are five unknown parameters here, it is advantageous to measure the response to the sinusoidal signals of at least five different frequencies.

As expressed in Equation [1], the output voltage includes the sum of the voltages in the first optical waveguide 23 and the second optical waveguide 24. This output voltage is the result of the overlapping actions of these two optical waveguides, and by identifying the parameters included in Equation [1], the tendency of the output voltage to decrease over time (rate of change over time) can be identified.

In this embodiment, a transfer function is set to monotonically increase the input voltage over time to compensate for the decrease in the output voltage over time. This makes it possible to compensate for the decrease in voltage due to the DC drift and suppress the decrease in the intensity of the output light. For example, the bias voltage supplied to the first electrode 31 and the second electrode 32 may be set to V=Vs (1+at). In this case, the bias voltage parameters Vs and a are determined from the parameters A, B, C, α, and β included in Equation [1].

The time constant of the DC drift has wavelength dependency. The shorter the wavelength of light, the smaller the time constant of the DC drift, and the more significant the decrease in the intensity of the output light over time. For this reason, it is advantageous to set the transfer function taking into consideration the wavelength dependency. More specifically, it is advantageous to set a transfer function that increases the bias voltage at a higher rate for the optical waveguide through which the light with a short wavelength travels.

For example, in the configuration shown in FIG. 1, a transfer function suitable for red light is set in the Mach-Zehnder optical waveguide 20A for modulating red light. A transfer function suitable for green light is set in the Mach-Zehnder optical waveguide 20B for modulating green light. A transfer function suitable for blue light is set in the Mach-Zehnder optical waveguide 20C for modulating blue light. This makes it possible to stabilize the intensity of each output light having a different wavelength, and also makes it possible to stably express an appropriate color even when a mixed color (intermediate color) is produced when light of different wavelengths is combined.

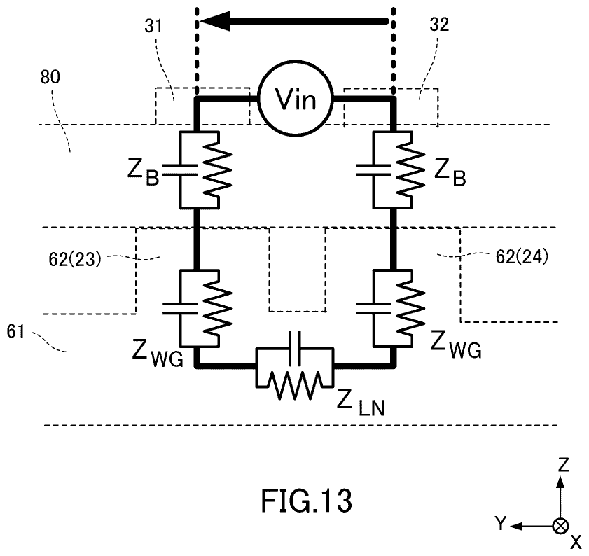

Further, for example, an equivalent circuit representing the operation and characteristics of the optical modulator 101 may be created, and the behavior of this equivalent circuit may be analyzed to determine the parameters of the transfer function to be implemented in the feedforward control circuitry 150. FIG. 13 is a diagram showing an example of an equivalent circuit that can be used in this embodiment.

FIG. 13 shows an equivalent circuit that models the cross-sectional structure of the optical modulation element 11 shown in FIG. 3. In the equivalent circuit of FIG. 13, impedance elements in which resistors and capacitors are connected in parallel are arranged in the buffer layer 80, the ridge portions 62, and the slab layer 61 between the ridge portions 62, and are connected in series. The equivalent circuit shown in FIG. 13 is only an example, and any model may be appropriately constructed in accordance with the characteristics of the optical modulation element 11.

The response to the input signal is calculated, and the parameters of the equivalent circuit are specified so that the response in the actual optical modulator 101 can be obtained. At this time, the values of each element of the equivalent circuit (resistance value and capacitance) are adjusted using, for example, actual measurement data. This allows the characteristics and operation of the actual optical modulator 101 to be reproduced using an equivalent circuit, and a transfer function for compensating for the decrease in output voltage over time can be obtained.

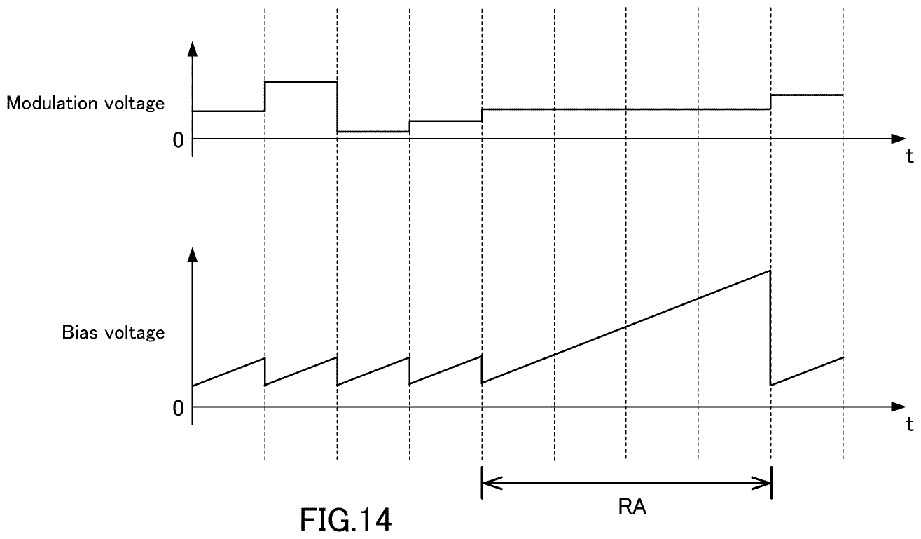

Hereinafter, the bias voltage output based on the transfer function will be explained. FIG. 14 is a diagram schematically showing the waveforms of the modulation voltage and the bias voltage used in the optical modulator 101 in this embodiment. A transfer function that monotonically increases the bias voltage supplied to the first electrode 31 and the second electrode 32 over time is set in the feedforward control circuitry 150 of the optical modulator 101.

As shown in FIG. 14, the modulation voltage changes in response to the color corresponding to each pixel. The bias voltage supplied to the first electrode 31 and the second electrode 32 is monotonically increased over time so as to compensate for the DC drift that occurs accompanied by the change in the modulation voltage. The bias voltage can be set, for example, to V=Vs (1+at). Here, as shown in FIG. 14, the bias voltage is set to linearly increase from the voltage Vs at a rate of change a, each time the modulation voltage changes. The voltage Vs may be set to coincide with the operating point, or may be set to a predetermined value higher than the operating point, taking into account the voltage drop over time due to the DC drift.

The monotonic increase of the bias voltage over time is reset at a timing when the modulation voltage changes, and then restarted with a predetermined value as the initial value. The feedforward control circuitry 150 may repeatedly perform the monotonic increase of the bias voltage over time in synchronization with the change in the modulation voltage. For example, the feedforward control circuitry 150 resets the monotonic increase of the bias voltage using a change in the modulation signal Sm as a trigger. In an example in which V=Vs (1+at) is set as the transfer function, the feedforward control circuitry 150 is configured to output the voltage value of the initial value Vs and the rate of change a, and each time the modulation voltage changes, the process of returning to the initial value Vs the voltage value increased by the amount of time that has passed is repeatedly performed. As a result, as shown in FIG. 14, the bias voltage forms a sawtooth waveform over time.

When pixels of the same color are lined up in succession, the modulation voltage does not change as shown in the region RA in FIG. 14, and as a result, the bias voltage continues to increase monotonically. Although the withstand voltage of the optical modulator 101 is sufficiently high and the possibility of reaching the allowable voltage value is low, if this state continues for a long time, there is a possibility that leads to excessive power consumption and temperature rise.

In consideration of such problems, the feedforward control circuitry 150 may be configured to return the bias voltage to a predetermined steady-state value when the bias voltage continues to increase monotonically and exceeds a predetermined upper limit value. It is advantageous to set the upper limit value to a value sufficiently smaller than the allowable voltage value, and it is even more advantageous to set the upper limit value so that the applied voltage does not deviate from the applied voltage range. In addition, an operating point may be set as a predetermined steady-state value. When the bias voltage that continues to increase monotonically is returned to the operating point, the bias voltage may be maintained at the operating point without increasing monotonically until the next timing when the modulation voltage changes.

Furthermore, the feedforward control circuitry 150 may be configured to reset the monotonic increase of the bias voltage using only an increase in the modulation voltage Vm as a trigger, and not to reset the monotonic increase of the bias voltage at a timing when the modulation voltage Vm drops.

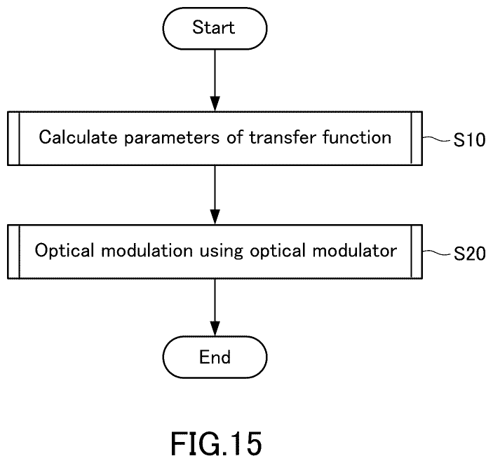

The operation of this embodiment will be described. FIG. 15 is a flowchart showing an outline of the optical modulation method of this embodiment. As shown in FIG. 15, the optical modulation method of this embodiment includes a process of setting a transfer function and calculating its parameters (step S10: transfer function calculation process), and a process of actually operating the light source module 201 to modulate and output visible light (step S20: modulated light output process).

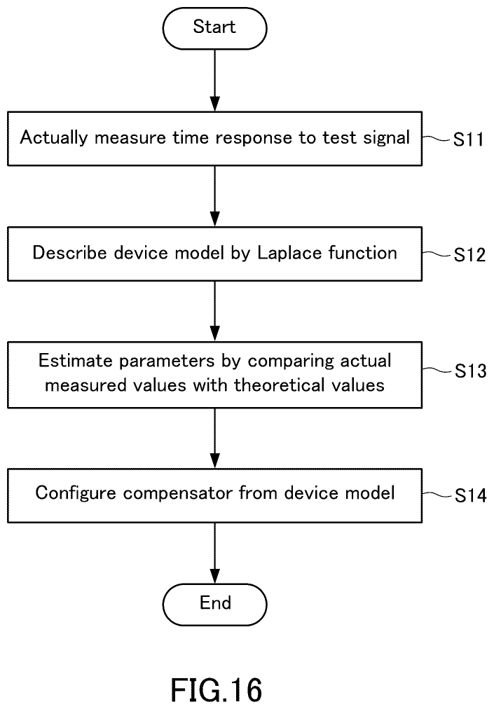

FIG. 16 is a flowchart showing the processing in the transfer function calculation process of this embodiment. FIG. 16 shows, as an example, a method of deriving the parameters of the transfer function to be set in the feedforward control circuitry 150 from the measurement data of the actual optical modulator 101.

The time response to the test signal is actually measured (step S11). A signal generator is connected to the first electrode 31 and the second electrode 32 of the actual optical modulator 101. A test signal (e.g., a sinusoidal wave) is input from the signal generator to the optical modulator 101, and the electrical response of the optical modulator 101 is measured using an oscilloscope or the like. The test signal is input multiple times with different frequencies to obtain multiple measurement data (actual measurements). The multiple measurement data include information for specifying the parameters of the transfer function that indicates the characteristics of the optical modulator 101.

A device model described by a Laplace function is constructed (step S12). Specifically, an equation expressing the characteristics of the optical modulator 101 is defined. Here, for example, the above Equation [1] including unknown parameters (A, B, C, α, and β) is set, and described by a Laplace function as in the above Equation [2]. In addition, the frequency response (amplitude response and phase response) when a sinusoidal wave is input is derived as in the above Equations [4] and [5].

The actual measured values are compared with the theoretical values to perform parameter estimation (step S13). For parameter estimation, multiple measurement data obtained in step S11 above are used. The analysis of these measurement data requires the computational power of a computer, and a parameter estimation device for executing numerical analysis and optimization algorithms is used. The measurement data includes information indicating the characteristics of the optical modulator 101, and the amplitude response and the phase response can be obtained from the response to the test signal. In step S12, the multiple measurement data are applied to the frequency response of the device model to perform a simultaneous solution, thereby obtaining unknown parameters (A, B, C, α, and β) from the actual measured values. This allows the actual measured values to be incorporated into the device model, thereby making it possible to complete a device model reflecting the DC drift characteristics.

A compensator is configured from the device model (step S14). In the feedforward control circuitry 150 as a compensator, a transfer function indicating the output voltage characteristics for compensating for the DC drift is set based on the device model. This transfer function outputs a voltage that increases monotonically over time from a predetermined initial voltage value, and for example may output a voltage that increases linearly over time. The feedforward control circuitry 150 is connected to the bias application circuitry 130. The feedforward control circuitry 150 is configured to output a voltage value calculated from the transfer function and to cause the bias application circuitry 130 to output a bias voltage corresponding to the voltage value. In this way, a transfer function that compensates for DC drift is set in the feedforward control circuitry 150, and the bias application circuitry 130 can supply a bias voltage that compensates for DC drift to the first electrode 31 and the second electrode 32 under the control of the feedforward control circuitry 150.

When the transfer function is obtained using an equivalent circuit, an equivalent circuit that reproduces the characteristics and operation of the optical modulator 101 is created. A plurality of test signals are input, impedance is measured, and fitting is performed with the actual measured value to complete an equivalent circuit model that reflects the characteristics of the actual optical modulator 101.

In the optical modulator 101 of the light source module 201, a transfer function that compensates for DC drift is set in the feedforward control circuitry 150. The feedforward control circuitry 150 compensates for the DC drift, and the light source module 201 can stabilize the characteristics of the output light.

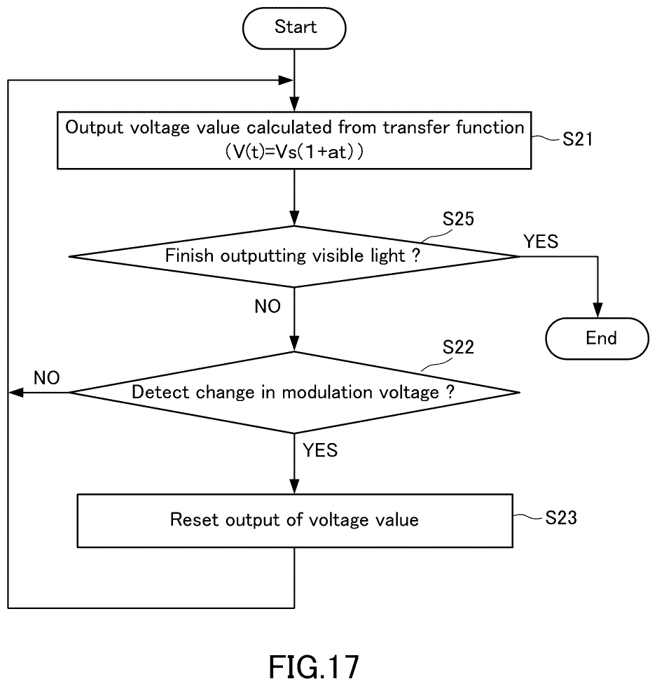

The processing of the feedforward control circuitry 150 in the modulated light output process will be described. FIG. 17 is a flowchart showing an example of the processing of the feedforward control circuitry 150 of the light source module 201 in this embodiment. The processing of the feedforward control circuitry 150 is not limited to the flowchart shown in FIG. 17.

When the light source module 201 starts outputting visible light, the feedforward control circuitry 150 starts feedforward control. The feedforward control circuitry 150 outputs a voltage value calculated from the transfer function (step S21). The processing of step S21 represents the continuation of the output of a voltage value (for example, V(t)=Vs (1+at)) that increases monotonically over time. That is, the feedforward control circuitry 150 continues to output a voltage value that monotonically increases over time to the bias application circuitry 130. The bias application circuitry 130 supplies a bias voltage corresponding to this voltage value to the first electrode 31 and the second electrode 32.

The feedforward control circuitry 150 performs the feedforward control until the light source module 201 finishes outputting visible light. If the light source module 201 continues to output visible light (“NO” in step S25), the feedforward control circuitry 150 continues the feedforward control. On the other hand, if the light source module 201 finishes outputting visible light (“YES” in step S25), the feedforward control circuitry 150 ends feedforward control.

The feedforward control circuitry 150 receives a modulation signal. The feedforward control circuitry 150 can detect a change in the modulation voltage based on the modulation signal. The modulation voltage corresponds to the intensity of the modulation voltage that changes the intensity of the output light.

The feedforward control circuitry 150 continues to output a voltage value that monotonically increases over time until the feedforward control circuitry 150 detects a change in the modulation voltage. If the feedforward control circuitry 150 does not detect a change in the modulation voltage (“NO” in step S22), the feedforward control circuitry 150 returns to step S21 and continues to output a voltage value that monotonically increases over time. While the feedforward control circuitry 150 does not detect a change in the modulation voltage, the feedforward control circuitry 150 loops through steps S21 and S22, and the voltage value continues to monotonically increase.

On the other hand, when the feedforward control circuitry 150 detects a change in the modulation voltage (“YES” in step S22), the feedforward control circuitry 150 resets the output of the voltage value (step S23). Resetting the output of the voltage value means returning the voltage value output in step S21 to the initial value (t=0). When the output of the voltage value is reset, the process returns to step S21 again, and a voltage value that monotonically increases over time is output. As a result, the feedforward control circuitry 150 continues to output a voltage value that monotonically increases over time while returning the voltage value to the initial value (t=0) every time a change in the modulation voltage occurs, that is, a change in the intensity of the output light occurs.

### Second Embodiment

The second embodiment of the present disclosure will be described. The same components as those in the first embodiment described above are denoted by the same reference numerals, and the description will be omitted as appropriate.

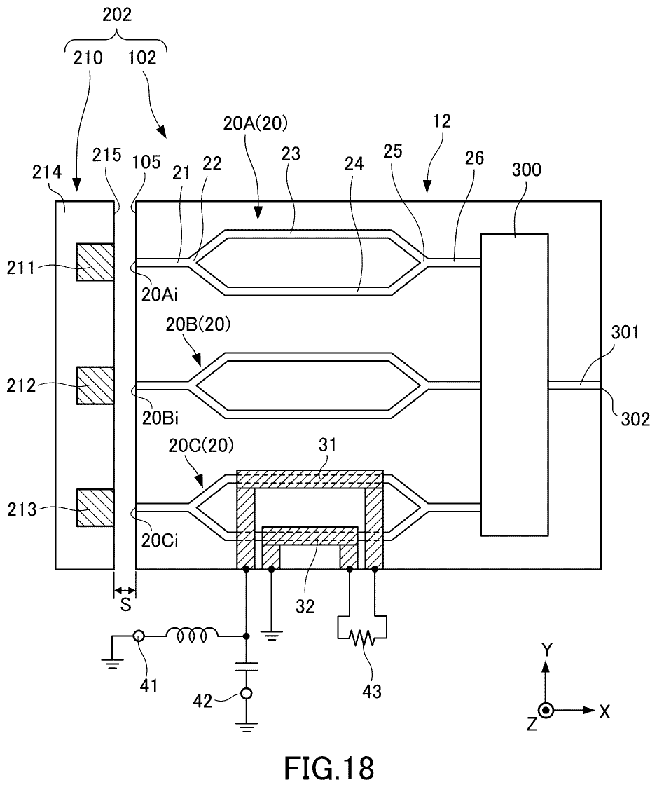

FIG. 18 is a schematic plan view of a light source module 202 in the second embodiment. The light source module 202 shown in FIG. 18 is configured to include a light source section 210 and an optical modulator 102.

The optical modulation element 12 of the optical modulator 102 in the second embodiment is provided with an optical multiplexing section 300 connected to the ends of the three Mach-Zehnder optical waveguides 20A, 20B, and 20C. The visible light of each color modulated by the three Mach-Zehnder optical waveguides 20A, 20B, and 20C is multiplexed in the optical multiplexing section 300. The light multiplexed in the optical multiplexing section 300 travels through the multiplexed optical waveguide 301 and is output from a single multiplexed optical output port 302. The optical multiplexing section 300 is not particularly limited, but is advantageously an interference type multiplexing section that multiplexes light of different wavelengths by interference. The method of mounting the optical multiplexing section 300 on the optical modulation element 12 is not particularly limited, but it is advantageously provided in the ferroelectric thin film 60.

In this way, by integrally mounting the optical multiplexing section 300 on the optical modulation element 12, it is possible to realize an optical modulator 102 that also functions as a multiplexer that multiplexes visible light of different wavelengths, and further miniaturization and high integration can be achieved.

### (Optical Engine and XR Glasses)

The present disclosure can provide an optical engine equipped with the light source modules 201 and 202 in the first and second embodiments described above. The optical engine is a device that includes the light source modules 201 and 202, an optical scanning mirror that reflects the light emitted from the light source modules 201 and 202 at different angles so as to display an image, and a control element that controls the optical scanning mirror.

Furthermore, the present disclosure can provide an image display device equipped with the above optical engine. The image display device is a device that displays information that can be visually recognized as an image (still image and moving image) by projecting visible light of a color corresponding to each pixel onto a screen or directly onto the human retina. The image display devices include, for example, XR glasses, projectors, displays, and the like. XR is a general term for virtual reality (VR), augmented reality (AR), and mixed reality.

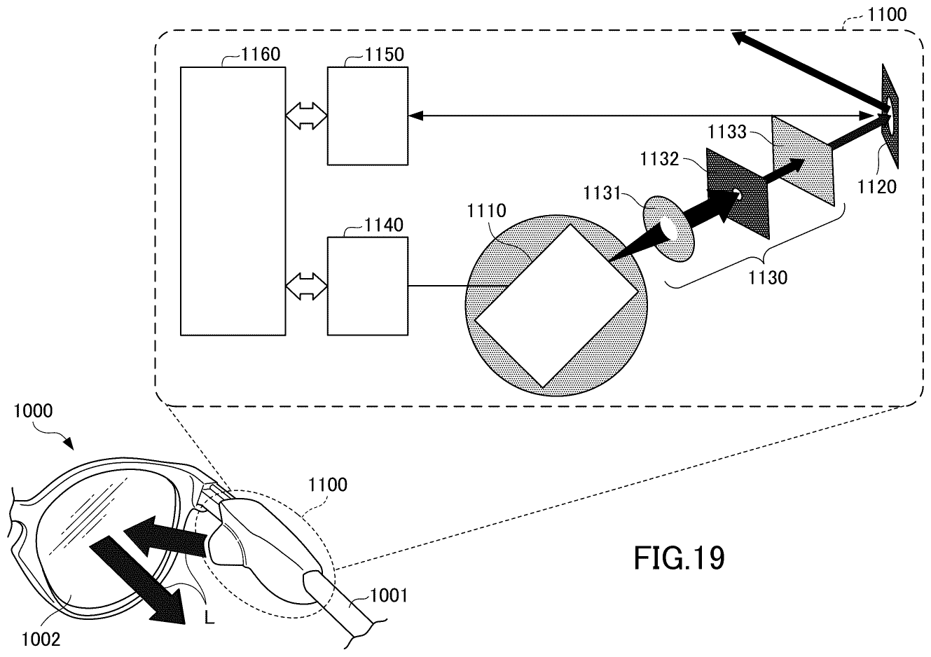

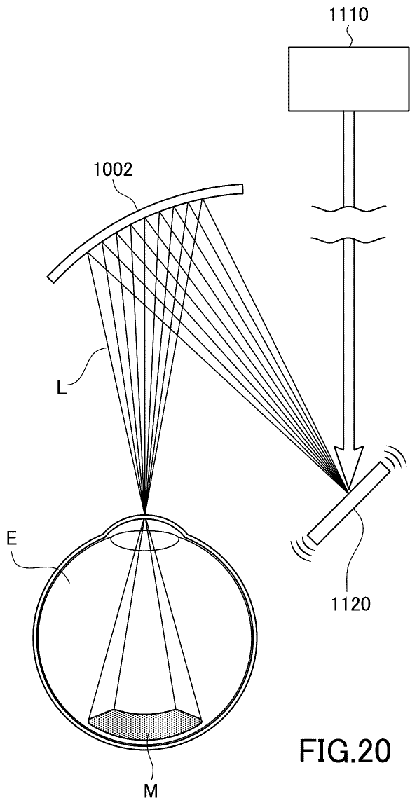

FIG. 19 is a conceptual diagram for explaining XR glasses 1000, which are an example of an image display device according to the present disclosure. FIG. 20 is a conceptual diagram showing how an image is projected directly onto the retina M by laser light R emitted from a light source module 1110 in the XR glasses 1000 shown in FIG. 19.

The XR glasses 1000 shown in FIG. 19 is a glasses-type terminal, and an optical engine 1100 is installed in a frame 1001 of the glasses. The optical engine 1100 is equipped with the light source modules 201 and 202 in the first or second embodiment described above as the light source module 1110. When the light source module 201 in the first embodiment described above is used, an optical multiplexer may be provided separately.

As shown in FIG. 19, the optical engine 1100 has a light source module 1110, an optical scanning mirror 1120, an optical system 1130 connecting the light source module 1110 and the optical scanning mirror 1120, a laser driver 1140, an optical scanning mirror driver 1150, and a video controller 1160 for controlling these drivers.

For example, a MEMS mirror can be used as the optical scanning mirror 1120. In order to project a two-dimensional image, it is advantageous to use, as the optical scanning mirror 1120, a two-axis MEMS mirror that vibrates so as to reflect laser light by changing the angle in the horizontal direction (X direction) and the vertical direction (Y direction).

The optical system 1130 optically processes the laser light emitted from the light source module 1110. One of the optical systems having, for example, a collimator lens 1131, a slit 1132, and an ND filter 1133 can be used as the optical system 1130. The optical system 1130 shown in FIG. 19 is an example, and other configurations may be used.

In the XR glasses 1000 shown in FIG. 19, as shown in FIG. 20, the laser light (image display light L) emitted from the light source module 1110 attached to the frame 1001 is reflected by the optical scanning mirror 1120 and further reflected by the lens 1002 of the XR glasses 1000. The reflected light (image display light L) reflected by the lens 1002 is incident on the human eyeball E and is imaged on the retina M that can be visually recognized as an image.

The optical engine and the image display device according to the present disclosure include the light source modules 201 and 202 in the first or second embodiment described above, and are excellent in stability of light intensity and color tone by compensating for DC drift.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### DESCRIPTION OF REFERENCE NUMERALS AND SIGNS

11, 12 Optical modulation element
20, 20A, 20B, 20C Mach-Zehnder optical waveguide
20Ai, 20Bi, 20Ci, 20i Input port
20Ao, 20Bo, 20Co, 20o Output port
21 Input optical waveguide
22 Branching section
23 First optical waveguide
24 Second optical waveguide
25 Multiplexing section
26 Output optical waveguide
31 First electrode
31a, 32a One end
31b, 32b Other end
32 Second electrode
41 First power source
42 Second power source
43 Termination resistor
50 Substrate
60 Ferroelectric thin film
61 Slab layer
62 Ridge portion
70 Protective layer
80 Buffer layer
101, 102 Optical modulator
105 Optical input surface
110 Control unit
120 Drive circuitry
130 Bias application circuitry
140 Feedback control circuitry
150 Feedforward control circuitry
201, 202 Light source module
210 Light source section
211, 212, 213 Light source
214 Subcarrier
215 Optical output surface
300 Optical multiplexing section
301 Multiplexed optical waveguide
302 Multiplexed optical output port
1000 XR glasses
1001 Frame
1002 Lens
1100 Optical engine
1110 Light source module
1120 Optical scanning mirror
1130 Optical system
1131 Collimator lens
1132 Slit
1133 ND filter
1140 Laser driver
1150 Optical scanning mirror driver
1160 Video controller

What is claimed is:

1. An optical modulator comprising:
an optical modulation element in which a plurality of optical waveguides are formed on a thin film made of a material having an electro-optic effect;
an electrode arranged on the thin film and applying an electric field to the plurality of optical waveguides;
drive circuitry configured to apply a modulation voltage to the electrode;
bias application circuitry configured to apply a bias voltage to the electrode;
feedforward control circuitry configured to compensate for DC drift occurring in the plurality of optical waveguides;
wherein
the feedforward control circuitry changes the bias voltage output by the bias application circuitry over time based on a transfer function previously set in accordance with the characteristics of the DC drift.

2. The optical modulator according to claim 1, wherein the feedforward control circuitry monotonically increases the bias voltage over time.

3. The optical modulator according to claim 1, wherein the feedforward control circuitry monotonically increases the bias voltage at a constant rate over time.

4. The optical modulator according to claim 1, wherein the feedforward control circuitry continues to monotonically increase the bias voltage after returning the bias voltage to a predetermined value at the timing when the modulation voltage changes.

5. The optical modulator according to claim 4, wherein an operating point voltage is set as the predetermined value.

6. The optical modulator according to claim 4, wherein a voltage higher than an operating point voltage is set as the predetermined value.

7. The optical modulator according to claim 4, wherein the feedforward control circuitry returns the bias voltage to a predetermined value when the bias voltage continues to increase monotonically and exceeds a predetermined upper limit value.

8. The optical modulator according to claim 7, wherein, after the bias voltage is returned to the predetermined value, the feedforward control circuitry maintains the bias voltage without increasing monotonically until a next timing when the modulation voltage changes.

9. The optical modulator according to claim 1, wherein the plurality of optical waveguides constitute a Mach-Zehnder type optical waveguide.

10. The optical modulator according to claim 1,
wherein
the plurality of optical waveguides constitute a plurality of Mach-Zehnder type optical waveguides, and
the feedforward control circuitry corresponding to each of the plurality of Mach-Zehnder type optical waveguides is provided.

11. The optical modulator according to claim 10,
wherein
visible light of a different wavelength is propagated through each of the plurality of Mach-Zehnder type optical waveguides, and
the feedforward control circuitry corresponding to each of the plurality of Mach-Zehnder type optical waveguides changes the bias voltage over time based on the transfer function previously set in accordance with each wavelength.

12. The optical modulator according to claim 11, wherein the transfer function is set to increase the bias voltage at a higher rate for an optical waveguide through which the light with a shorter wavelength travels.

13. The optical modulator according to claim 9, wherein the Mach-Zehnder type optical waveguide has an input optical waveguide, a branching section that branches the input optical waveguide, a first optical waveguide and a second optical waveguide extending parallel to each other from the branching section, a multiplexing section that couples the first optical waveguide and the second optical waveguide, and an output optical waveguide extending from the multiplexing section.

14. The optical modulator according to claim 1, wherein parameters of the transfer function are set based on measurement results in an actual optical modulator.

15. The optical modulator according to claim 1, wherein parameters of the transfer function are set based on analysis results of an equivalent circuit that models the optical modulator.

16. The optical modulator according to claim 1, wherein the transfer function F(s) of the feedforward control circuitry and a transfer function G(s) of the optical modulator that serves as a controlled object are set such that F(s)·G(s)=1.

17. The optical modulator according to claim 1, wherein the feedforward control circuitry repeatedly performs a monotonic increase of the bias voltage followed by a reset of the bias voltage, so that the bias voltage forms a sawtooth waveform over time.

18. A light source module, comprising the optical modulator according to claim 1, and a plurality of light sources each emitting visible light of a different wavelength.

19. The light source module according to claim 18, wherein the plurality of light sources include laser diodes that respectively emit red light with a peak wavelength of 610 to 750 nm, green light with a peak wavelength of 500 to 560 nm, and blue light with a peak wavelength of 435 to 480 nm.

20. An optical modulation method for modulating light propagating through a plurality of optical waveguides using an optical modulator, the optical modulator including an optical modulation element in which a plurality of optical waveguides are formed in a thin film made of a material having an electro-optic effect, and an electrode for applying an electric field to the plurality of optical waveguides, the optical modulation method comprising:
setting a transfer function in accordance with the characteristics of DC drift occurring in the plurality of optical waveguides, and calculating parameters of the transfer function;
applying a modulation voltage and a bias voltage to the electrode to modulate the light propagating through the plurality of optical waveguides; and
performing feedforward control to change the bias voltage over time based on the transfer function, thereby compensating for the DC drift occurring in the plurality of optical waveguides.
